(19) United States
(12) Patent Application Publication
(10) Pub. No.: US 2026/0064774 A1
(43) Pub. Date: Mar. 5, 2026

(54) On-The-Fly Main Memory Graph Indexes For Index Based Graph Algorithm Runtime In An RDBMS

(71) Applicant: Oracle International Corporation, Redwood Shores, CA (US)

(72) Inventors: Marco Arnaboldi, Zurich (CH); Aleksa Milisavljevic, Loznica (RS); Hugo Kapp, Zurich (CH); Laurent Phillipe Daynes, Saint-Ismier (FR); Vlad Ioan Haprian, Zurich (CH)

(21) Appl. No.: 19/047,366

(22) Filed: Feb. 6, 2025

Related U.S. Application Data
(60) Provisional application No. 63/688,676, filed on Aug. 29, 2024.

(51) Int. Cl. G06F 16/901; G06F 16/22

(52) U.S. Cl. CPC G06F 16/9024; G06F 16/2282

(57) ABSTRACT

In response to a user invoking a graph operation on a graph in an in-memory graph algorithm (IMGA) runtime in a relational database management system (RDBMS), the RDBMS generates a set of one or more graph indexes in memory. The graph is represented as one or more vertex tables and one or more edge tables. The RDBMS generates the set of one or more graph indexes by generating a mapping of each database table vertex identifier to a corresponding internal identifier. For each edge table of the one or more edge tables, the RDBMS generates a graph index data structure representing edges of the edge table. The graph index data structure represents each edge in the edge table as a source internal identifier and a destination internal identifier. The RDBMS can then execute the graph operation in the IMGA runtime using the set of one or more graph indexes.

### BENEFIT CLAIM

This application claims the benefit of Provisional Application No. 63/688,676, filed Aug. 29, 2024, the entire contents of which is hereby incorporated by reference as if fully set forth herein, under 35 U.S.C. § 119(e).

### FIELD OF THE INVENTION

The present invention relates to on-the-fly main memory graph indexes for a relational database management system with graph analytics features.

### BACKGROUND

Demand is growing for graph analytics on data that resides in relational databases. Until recently, the solutions proposed to users involve constructing graphs outside of the databases holding the data of interest. One solution involves constructing graphs in dedicated graph analytic engines, while the other one involves migrating data to a graph database. These solutions are not satisfying as they substantially increase the complexity of data management in enterprise and lead to significant loading/data transfer costs to external engines. To address these challenges, relational databases can be extended with data definition languages (DDLs) that allow users to define a graph over existing or new database tables, and with graph querying and algorithms capabilities.

However, without special support, performance of graph analytics, like graph pattern match querying, or graph algorithms execution, or combination of both, will be notably worse than the performance offered by dedicated graph engines, especially for algorithms. In particular, graph indexes allowing fast navigation through the elements of a graph are essential for performance. Compressed sparse row (CSR) is a main-memory representation of the relationships between graph vertices with proven performance characteristics that has made it a de facto basic block in many academic and industrial graph analytic engines. A graph can be composed of several kinds of relationships and vertices. For example, a graph may be defined over many vertex or edge tables, where edges table may represent the different relationships between vertex tables. As a result, a single CSR is not enough to model this scenario. Instead, the heterogeneous nature of the data defining the graph requires using multiple CSRs.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 illustrates differences between homogeneous and heterogeneous graph indexes in accordance with an embodiment.

FIG. 2 illustrates classifications of a graph topology and how they are related in accordance with an embodiment.

FIG. 3 illustrates how a heterogeneous CSR is built from vertex and edge tables in accordance with an embodiment.

FIG. 4 illustrates the execution of the Bellman-Ford algorithm on a graph in accordance with an embodiment.

FIG. 5 is a block diagram illustrating Bellman-Ford algorithm execution using an In-Memory Graph Algorithm Runtime Application Programming Interface in accordance with an embodiment.

FIG. 6 illustrates mapping between ROWIDs and internal vertex identifiers in accordance with an embodiment.

FIG. 7 is a flowchart illustrating on-the-fly graph index construction in accordance with an embodiment.

FIG. 8 illustrates an on-the-fly property graph topology structure in accordance with an embodiment.

FIG. 9 illustrates graph operation execution integrated with an index-based graph algorithm engine in accordance with an embodiment.

FIG. 10 illustrates the iteration pipeline with the interface exposed by the on-the-fly graph index to the In-Memory Graph Algorithm Runtime in accordance with an embodiment.

FIG. 11 illustrates the process of property materialization in accordance with an embodiment.

FIG. 12 is a block diagram that illustrates a computer system upon which aspects of the illustrative embodiments may be implemented.

FIG. 13 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments attempt to reduce the gap, both in terms of performance and solution complexity, between SQL based graph algorithm runtimes and index-based graph algorithm runtimes. In response to a user invoking a graph operation on a graph in an in-memory graph algorithm (IMGA) runtime in a relational database management system (RDBMS), the RDBMS generates a set of one or more graph indexes in memory. The graph is represented in the RDBMS as one or more vertex tables and one or more edge tables. The RDBMS generates the set of one or more graph indexes by generating a mapping of each database table vertex identifier to a corresponding internal identifier. For each edge table of the one or more edge tables, the RDBMS generates a graph index data structure representing edges of the edge table. The graph index data structure represents each edge in the edge table as a source internal identifier and a destination internal identifier. The RDBMS can then execute the graph operation in the IMGA runtime using the set of one or more graph indexes. In response to completion of execution of the graph operation, the RDBMS removes the set of one or more graph indexes from memory.

Thus, the illustrative embodiments provide efficient construction of on-the-fly graph element identifiers. The embodiments map dense unsigned integers to unsigned integer identifiers. The on-the-fly graph element identifiers are used for CSR navigation and vertex/edge identification. The illustrative embodiments also provide efficient construction of on-the-fly CSR data structures. The embodiments provide a service for constructing CSR indexes at algorithm startup and a new CSR format for reducing memory footprint. The illustrative embodiments also provide an on-the-fly graph topology including a collection of CSRs representing a full graph. Furthermore, the illustrative embodiments provide seamless integration with existing index-based runtime. A set of Application Programming Interfaces (APIs) and graph iterators can be easily plugged into an existing RDBMS index-based graph algorithm runtime, thus providing a graph runtime with improved performance without added complexity to achieve Multi-Version Concurrency Control (MVCC).

Heterogeneous Vs. Homogeneous Graph Index

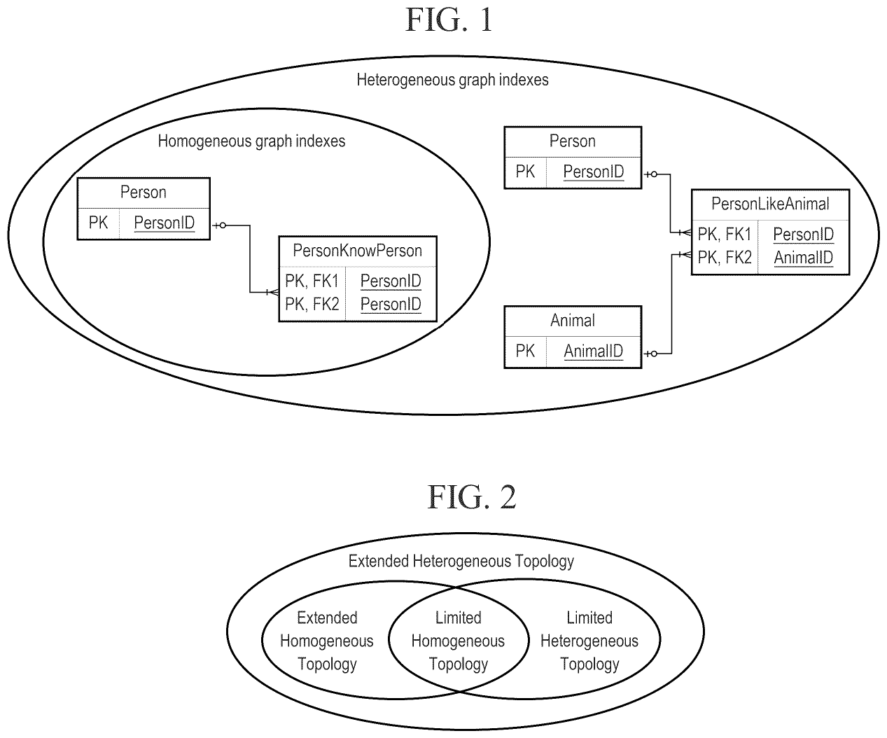

FIG. 1 illustrates differences between homogeneous and heterogeneous graph indexes in accordance with an embodiment. Note that the case of homogeneous graph indexes is a special instance of the more generic heterogeneous case; therefore, proving support for the latter implies providing support for the former. A graph index represents a relation between source and destination vertices, expressed as an edge between the source vertex and the destination vertex. In a graph defined over RDBMS tables, the graph index definition can be refined to a data structure representing a relation between a source and a destination vertex table via an edge table.

A homogeneous graph index involves at most two tables. A typical example of this case is an M-M relation expressed via an edge table (e.g., Friendship) on a vertex table (e.g., Person). Homogeneity consists in the fact that all the vertices in the graph indexes belong to the same relational table (i.e., they are of the same type). Another case of a homogeneous graph index is the one of a 1-M relation (e.g., Reporting Manager) on the same table (e.g., Employees), which in this case is both an edge and a vertex table.

A heterogeneous graph index involves two or three distinct tables. In this case the most common example consists in a M-M relation expressed via an edge table (e.g., Feelings) on two vertex tables (e.g., Person and Animals). Heterogeneity consists in having different kinds of vertices coming from different relational tables. The same applies to a 1-M relation (e.g., Owner) between two different source (e.g., Person) and destination (e.g., Car, assuming a car can be owned only by one person) vertex tables.

Thus, a homogeneous graph index is a specialization of a heterogeneous one. A homogenous graph CSR can be seen as a heterogeneous CSR where the source and destination tables are the same table representing the same vertex type.

### Graph Topology Classification

FIG. 2 illustrates classifications of a graph topology and how they are related in accordance with an embodiment. The graph topology terminology refers to the shape of the graph in terms of the number of relations and kinds of vertices defined in the graph. In a RDBMS this general definition can be refined into the following: the topology of a graph depends on the number of tables and graph indexes involved in its definition.

A limited homogeneous topology is the most specific case, because it involves at most two relational tables (one for the edges and one for the vertices). In this case, a graph is composed of a single homogeneous graph index defined for the tables involved.

A limited heterogeneous topology includes the limited homogeneous case, as shown in FIG. 2. In this kind of topology, two or three distinct relational tables are involved in the graph, two distinct source and destination vertex tables and one edge table. It is basically composed of a single heterogeneous graph index.

An extended homogeneous topology includes the limited homogeneous case. In the extended homogeneous case, the graph is composed of several homogeneous graph indexes (meaning several tables). Therefore, it is trivial to express a limited homogeneous graph topology as an extended one where the number of graph indexes is equal to one. Please note that this is a truly corner case, included here for the sake of completeness.

Finally, the extended heterogeneous topology, the most generic case that can be specialized in the three aforementioned ones. In this case, a graph is composed of one or more than one heterogeneous graph indexes (hence, several relational tables).

### Persistent Graph Index

Persistent graph indexes in an RDBMS have the same properties, behavior, and challenges of well-known databases indexes (e.g. B-Tree). Such indexes can be stored either in memory, on disk, or in a hybrid fashion. Like classic database indexes, persistent graph indexes amortize their construction cost by being used multiple times and by multiple workloads. Persistent graph indexes are able to represent all the cases shown in FIG. 2. Like other indexes, graph indexes are not immune to Data Manipulation Languages (DMLs) resulting in insertion, deletions, and modifications of vertices and edges. This requires the indexes to support Multi-Version Concurrency Control (MVCC) models for handling such cases.

### Graph Algorithm Runtime

A graph algorithm runtime allows execution of graph algorithms. A graph algorithm runtime is executed as a service in a dedicated query node in the execution tree of a Structured Query Language/Property Graph (SQL/PG) query.

### Graph Index-Based Algorithm Runtime

A graph index-based algorithm runtime allows users to execute graph algorithms, exploiting graph indexes existing in the system in order to achieve low latency. A graph index-based algorithm runtime takes advantage of the iterator Application Programming Interface (API) provided by the index in order to execute the corresponding algorithm in the most efficient way.

### SQL-Based Algorithm Runtime

A SQL-based algorithm runtime allows users to execute graph algorithms without requiring a graph index. The algorithm is implemented as a series of automatically generated SQL statements, usually repeated multiple times. This results in a significantly higher latency for graph algorithm execution compared to graph index-based solutions.

### Filling the Gap

Structured Query Language (SQL) engines have been optimized for a long time, and their performance for data processing tasks is typically very good. In practice, SQL-based execution does not provide the same level of performance, by more than an order of magnitude, when compared to index-based solutions. This is mainly due to SQL engines not being able take advantage of domain specific knowledge about graph processing. To summarize, SQL-based solutions have a worse performance, based on a Query Per Second (QPS) metric, than index-based ones.

On the MVCC side, SQL-based solutions provide an easier way to handle graph modifications. Transactional consistency is guaranteed by the query layer itself, resulting in basically no need for a specific MVCC model. The already existing model can be fully exploited by such solutions.

By exploiting domain-specific knowledge, an index-based algorithm runtime is able to achieve orders of magnitudes higher QPS than a SQL-based solution. On the MVCC side, basic implementations of graph indexes (e.g., CSR) do not provide any support for handling graph modifications. Persistent graph index-based solutions require more complex and sophisticated MVCC methods and data structures. The complexity lies in tracking changes at DML time and applying them to the index at commit time. In an extended heterogeneous topology, a single insert on one table may result in updating multiple indexes in multiple different ways (e.g., edge insertion, vertex insertion). As a result, commit operations become more expensive, resulting in a lower DML rate in case of graph indexes.

The illustrative embodiments attempt to solve how to construct on-demand graph indexes at algorithm execution time. To achieve lower latency compared to a SQL-based runtime and to avoid complex MVCC solutions, the illustrative embodiments exploit the fact that the service can use existing query transactional mechanisms.

The problem can be decomposed in three sub-challenges in the RDBMS scenario:
Heterogeneous Extended topology support: This feature consists in allowing algorithm execution on graphs of any shape.
Performance: Compressed Sparse Row (CSR) has proven to be the most efficient data structure to use in order to navigate through the relationships of a graph, becoming the de facto solution for almost any graph analytical engine. The challenge is once again twofold: efficiently building CSRs from relational data and allowing fast access to them.
Graph index-based algorithm runtime integration: The on-demand graph construction can seamlessly integrate with existing solutions (if present) in the RDBMS system, without requiring users to rewrite/implement their graph algorithms.

Most graph analytic engines use CSR graph indexes stored in main memory to speed up graph processing workloads. Proposed solutions fall into three categories:
RDBMS with graph analytics features: This category contains all the databases built on top of the well-known entity-relationship (ER) model. This kind of RDBMS is the most widespread (e.g., Microsoft SQL Server, SAP HannaH) and allows both in-memory features (in order to speed up queries, especially joins) and some graph support. It is possible that this category may support only homogeneous graphs. The way in which the homogeneous graphs are constructed in these systems is not known since they represent proprietary solutions.
Standalone graph processing systems: This category contains all the graph analytics engines working outside of data stores (e.g., Oracle PGX). This means that graph data is exported and transferred from the RDBMS to the system in which the engine is running. In this case, the graph index is built in-memory, but on the external graph engine. Depending on the engine, different loaders may be used to build the graph index, depending on the kind of format in which the data were exported.
Graph database systems: This category comprises systems specifically optimized to map, store, and traverse networks of highly connected data (e.g., Neo4J, JanusGraph). Data is directly created/stored in the graph database and managed from it.

The solution provided by the illustrative embodiments fits in the first category. The solution increase RDBMS competitiveness in the graph algorithm processing field, by improving adoption of graph index-based algorithm runtime.

The solution of the illustrative embodiments attempts to reduce the gap, both in terms of performance and solution complexity, between SQL-based graph algorithm and index-based graph algorithm runtime. The resulting approach can be seamlessly integrated in existing relational database management systems with index-based runtime. In this scenario, the solution provides a new option to use such systems without requiring users to create indexes beforehand, resulting also in improving all the graph index management required at DML commit time. In some embodiments, only one portion of the graph can be kept consistent and only the other part being constructed on demand. The solution can be also applied to relational database management systems providing graph functionality, but not index-based graph algorithm runtime. In this scenario, the solution can be the key enabler for the implementation of such runtime without requiring the design and implementation of a complex MVCC model for the graph index.

### Compressed Sparse Row

Relational database management systems aim to efficiently process relational data, i.e., data stored as tables that are connected together through Primary Key/Foreign Key relationships. Relational data can be seen as graph data: Primary Key/Foreign Key relationships can be understood as edges. More specifically, a property graph allows for vertex and edges to carry properties. Relational data can be seen as a graph as follows: a row of a table holding columns with foreign key constraint to two other tables can be seen as an edge with property between these two tables. A collection of such triple of tables can be seen as a graph.

Main memory graph representations, such as adjacency lists/matrices can then be built on top of the relational data. This is particularly beneficial for graph pattern matching queries or graph algorithms, such as Pagerank, as exploring the topology (i.e., following edges) can be done in memory, without using a succession of JOIN operations that would be very time-consuming and would require the materialization of intermediate results. Since main memory graph representations that are built on top of relational data make it possible to speed up these classes of workloads, they are effectively indexes, referred to as graph indexes.

An efficient and commonly used main memory representation of a graph topology is the Compressed Sparse Row (CSR) representation. The CSR representation is a compact representation of an adjacency list in only two arrays, named source array and destination array. In some embodiments, the CSR representation assumes that vertices are indexed by contiguous integers starting from 0. The destination array contains the indices of the neighbor of each source vertex in the graph, ordered by the source vertex index. The source array contains, at index i, the index in the destination array at which the neighbor list for source vertex i starts, and at index i+1, the index in the destination array after which the neighbor list for source vertex i ends.

CSRs (as graphs) can be categorized in two different kinds, namely homogeneous and heterogeneous. A homogeneous CSR represents an N to M relation on the same vertex table. A heterogeneous CSR represents an N to M relation between two different tables. Because the former is a special (and simpler) specialization of the latter, the illustrative embodiments are described with reference to the heterogeneous case in further detail below. By supporting the more generic case (heterogeneity), the illustrative embodiments inherently support the homogeneous specific case.

For heterogeneous CSRs, the source array is indexed over the source vertex table private key (PK) to identifier (ID) mapping. In this case, the stored values are not the IDs mapped with the PK of the source table; instead, they are the IDs mapped with the PK of the destination table. The homogeneous case is a specialization of the above, since the IDs of the destination array are based on the same mapping used for the source table and the CSR source array. Therefore, only one mapping is required.

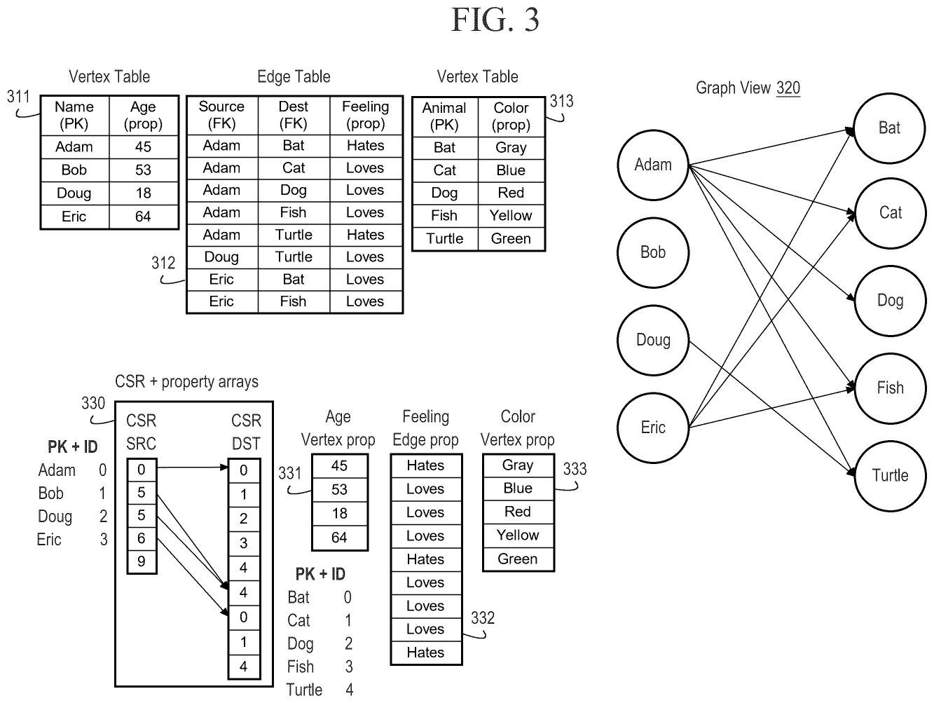

FIG. 3 illustrates how a heterogeneous CSR is built from vertex and edge tables in accordance with an embodiment. The relational data consists of three tables 311, 312, 313. Table 311 has two columns named “Name” and “Age,” with “Name” being the primary key. Table 311 is the source vertex table: each row from this table corresponds to a source vertex in the graph, as shown in graph view 320.

Table 312 has two foreign keys, “Source” and “Dest,” that map to the primary key of, respectively, a source vertex table (table 311) and a destination vertex table (table 313). This second table 312 is the edge table, and each one of its rows will correspond to an edge in the graph. In addition to its two foreign keys, the edge table has another column, “Feeling.” This column is a property of edges. It contains information about the relationship it expresses between persons from table 311 and animals table 313.

Table 313 has two columns named “Animal” and “Color,” with “Animal” being the primary key. Table 313 is the destination vertex table: each row from this table corresponds to a destination vertex in the graph. As shown in FIG. 3, persons and animals are two totally different types of vertices, represented in two different relational tables. The edge table describes an N:M relationship between these two tables.

As seen in tables 311, 312, 313 and graph view 320, the vertex “Adam” has edges to the vertices Bat and Turtle with the Feeling property of “Hates” and edges to vertices Cat, Dog, and Fish with the Feeling property of “Loves”; the vertex Bob does not have any outgoing edges; the vertex “Doug” has an edge to the vertex Turtle with the Feeling property of “Loves”; and, the vertex Eric has edges to the vertices Bat and Fish with the Feeling property of “Loves.” CSR 330 includes CSR SRC representing the source vertices for the edges and CSR DST representing the destination vertices for the edges. Each element of CSR SRC corresponds to a vertex in source vertex table 311, except the last element, which is a pointer to the last element of CSR DST.

CSR SRC includes, for each source vertex, a pointer to a position in the CSR DST containing a list of the destination vertices. Thus, the first element in CSR SRC represents outgoing edges from the source vertex Adam. The second element in CSR SRC represents outgoing edges from the source vertex Bob. Each element in CSR DST from the first position to the position before the start of list for vertex Bob represents a vertex in the destination vertex table 313. Note that these point to the same position in SRC DST, which indicates that source vertex Bob does not have any outgoing edges.

Age vertex properties 331 correspond to the Age properties of source vertex table 311. Feeling edge properties 332 correspond to the Feeling properties of edge table 312. Color vertex properties 333 correspond to the Color properties of vertex table 313. Together, CSR 330, Age vertex properties 331, Feeling edge properties 332, and Color vertex properties 333 are another representation of the graph in tables 311, 312, 313 and graph view 320.

### Graph Algorithms

Meaningful questions that can be asked about the given graph data are significantly different to those for the standard relational data. For example, one could ask whether two vertices of the graph are connected. Even writing down such a question in the terms of the relational queries would produce a very complex query with multiple joins. This entails a different approach to retrieving information or statistics from the given data. Graph algorithms are one natural framework for analyzing graphs and retrieving meaningful information from it. An example of such an algorithm is Bellman-Ford, which can be used to calculate the shortest distances in a weighted graph from a specified vertex to all the other vertices.

A syntax for executing the Bellman-Ford graph algorithm is as follows:

```
SELECT *
FROM GRAPH_TABLE (
  DBMS_OGA.bellman_ford(
    graph,
    START_VERTEX( ),
    PROPERTY(EDGE INPUT weight DEFAULT ON NULL 100),
    PROPERTY(VERTEX OUTPUT BELLMAN_FORD_DIST),
    max_hops = 3)
  MATCH (v)
  COLUMNS (v.BELLMAN_FORD_DIST))
ORDER BY BELLMAN_FORD_DIST ASC;
```

In the above syntax, graph is the property graph object on which the algorithm is executed, START_VERTEX ( ) is the function that returns the start vertex in the JSON format, PROPERTY (EDGE INPUT weight DEFAULT ON NULL 100) is the property of each edge that describes the weight for Bellman-Ford, PROPERTY (VERTEX OUTPUT BELLMAN_FORD_DIST) is the output property for each vertex, and max_hops is the maximal number of hops for Bellman-Ford. The start vertex in the JSON format is a vertex identifier object, which may include a graph owner, a graph name, an element table, and a key value.

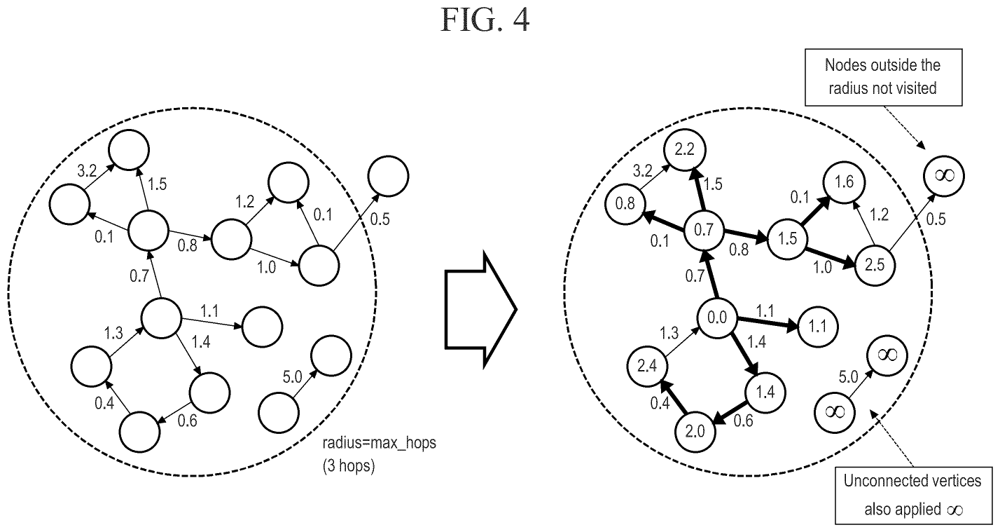

FIG. 4 illustrates the execution of the Bellman-Ford algorithm on a graph in accordance with an embodiment. The Bellman-Ford algorithm takes the following arguments:
graph describes the structure on the left, i.e. all the vertices, edges between them and properties of those vertices and edges.
START_VERTEX ( ) is a function that would return the starting vertex for the Bellman-Ford execution, i.e. the one with the yellow bordering in the figure.
PROPERTY(EDGE INPUT weight DEFAULT ON NULL 100) describes the input property of each vertex that defines the weight of edges to be used by the Bellman-Ford, i.e., the numbers written next to edges in the figure.
PROPERTY (VERTEX OUTPUT BELLMAN_FORD_DIST) describes the output of the algorithm. In the case of Bellman-Ford, this output is the shortest distance from the given vertex. The output distances are written inside each vertex in the right part of FIG. 4.
max_hops=3 describes the number of hops used for the execution of the Bellman-Ford, which restricts the paths we are considering to length at most max_hops.

The edges that can be legally taken under the Bellman-Ford algorithm with max_hops=3 are shown in bold on the right. The weights are added up and shown in the vertex in the right part of FIG. 4. Note that unconnected vertices and vertices that cannot be reached in three hops have an infinite result, as shown in FIG. 4.

The following Table 1 shows the output of the Bellman-Ford algorithm shown above and in FIG. 4:

TABLE 1

| VERTEX_ID | BELLMAN-FORD DISTANCE |
|---|---|
| 0 | 1.1 |
| 1 | 2.2 |
| 2 | 0.7 |
| 3 | inf |
| 4 | 2.5 |
| 5 | 1.4 |
| 6 | inf |
| 7 | 0.8 |
| 8 | 1.6 |
| 9 | 2.0 |
| 10 | inf |
| 11 | 0.0 |
| 12 | 1.5 |
| 13 | 2.4 |

### Index-Based Graph Algorithm Runtime

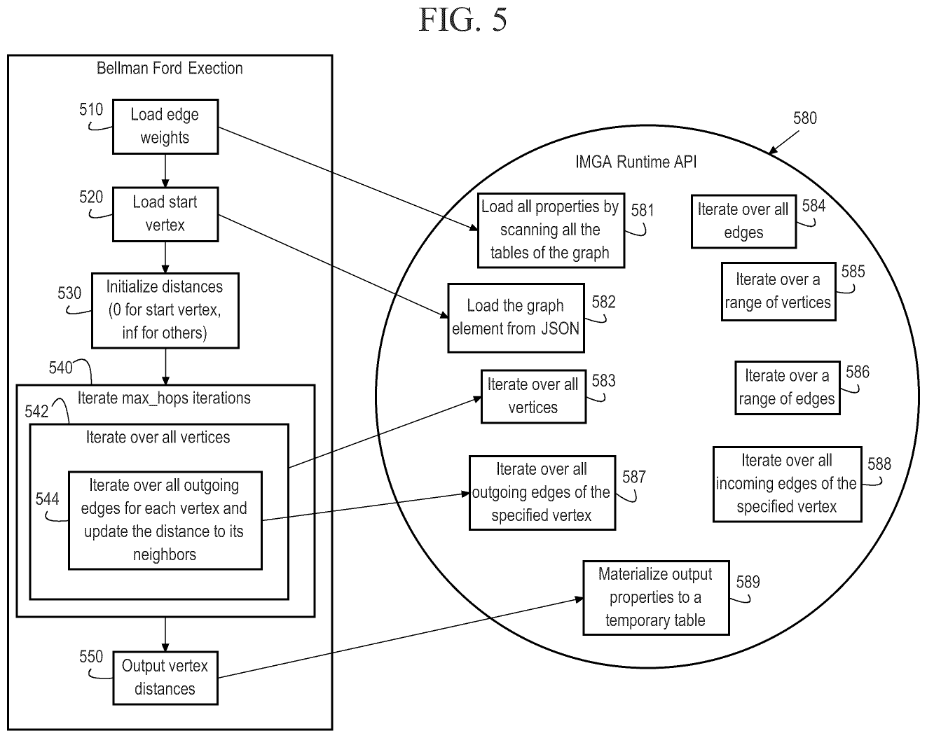

FIG. 5 is a block diagram illustrating Bellman-Ford algorithm execution using an In-Memory Graph Algorithm Runtime Application Programming Interface in accordance with an embodiment. In-Memory Graph Algorithm (IMGA) runtime is the intermediate layer between the algorithm implementation and the in-memory representation of the graph topology (i.e., the graph index such as CSR). IMGA presents an interface, IMGA Runtime API 580, to the implementation of the algorithms. Algorithm implementation itself is abstracted to work on any graph and uses this interface in order to execute on the graph specified by the user. In general, functionalities provided by the IMGA are those that are required by the implemented algorithms. For those functionalities IMGA relies on the interface provided by the graph index.

The functionalities provided by the IMGA Runtime API 580 include loading the necessary properties (such as edge weights in the Bellman-Ford) 581, loading the specific graph elements (e.g., start vertex for the Bellman-Ford algorithm) 582, iterating over vertices 583, iterating over edges 584, iterating over a range of vertices 585, iterating over a range of edges 586, iterating over the outgoing edges of the specified vertex 587, iterating over the incoming edges of the specified vertex 588, and materializing the output properties (such as vertex distances in the case of Bellman-Ford) 589. Mentioned iterators are robust and they provide options for iterating over all elements of the specified kind or only over the range of them. Sequential and parallel variants of those iterators may also be provided.

FIG. 4 illustrates an example of interaction between the execution of the Bellman-Ford algorithm and IMGA Runtime API 580. The execution of the algorithm then invokes some of the functionalities exposed by The IMGA Runtime API 580. Most of the algorithm implementations follow this pipeline, first loading the properties and elements, then iterating over the graph in the main part of the execution and finally materializing the output properties.

At the beginning, algorithm execution calls upon the runtime to load the edge weights (block 510). In order for the later iteration, those weights need to be ordered in the same way as they are in the destination array of the CSR. After this step, algorithm execution invokes the IMGA Runtime API to fetch the start vertex (block 520). The start vertex is defined by the user based on its primary key in the corresponding vertex table. This value must be translated to the internal vertex identifier, i.e., the CSR indexing of the source array

During the main loop, algorithm execution initializes distances (block 530) and iterates over various graph elements (block 540). First, the algorithm execution iterates over all vertices (block 542) and iterates over all outgoing edges for each vertex and updates the distance to its neighbors (block 544). Each of those iterations is forwarded by the IMGA to the underlying graph index, which then handles the iteration.

Finally, algorithm execution materializes the distances that were calculated during the execution. Algorithm execution then provides the output in an array (block 550), which is ordered by the internal vertex identifiers, i.e., by the CSR indexing. For materializing the output, the algorithm execution scans vertex tables and for each vertex, the corresponding CSR index is determined. This index is then used to fetch the output value from the array provided by the algorithm.

### On-the-Fly Graph Index

When the user invokes the graph algorithm function, a CSR is constructed on-the-fly. This CSR is then exposed through an interface to the IMGA runtime, which calls for iteration over its source and destination arrays, queries for the mappings of vertices, etc. Notice that some algorithms (such as Weakly Connected Components) may require iteration over the incoming edges. CSR as described above is inconvenient for this type of iteration. Therefore, if required by the algorithm, a reverse CSR is constructed. In the reverse CSR, the roles of the source and destination vertex tables are swapped. The new source array contains vertex identifiers of the original destination vertex table. The new destination array has the same size as the original one, but instead it contains the list of sources pointing to the corresponding destination. A reverse CSR is also constructed on-the-fly, if it is required by the algorithm. Input properties are not duplicated by the reverse CSR. The lifetime of the on-the-fly graph index is tied to the execution of the algorithm. As soon as algorithm completes execution, the index is not necessary and is dropped.

### On-the-Fly Graph Identifiers

Each vertex in the graph can be identified with one row of some vertex table. Each row has a physical identifier (ROWID). Some relational database management systems do not provide dense physical identifiers. The illustrative embodiments use these ROWID identifiers to generate internal vertex identifiers that are used for the index CSR source array. Generating internal vertex identifiers includes scanning each vertex table, ordered increasingly by ROWID. Syntax for constructing a single CSR is as follows:
SELECT Vertex.rowid, [Vertex.properties . . . ]
FROM Vertex
ORDER BY Vertex.rowid

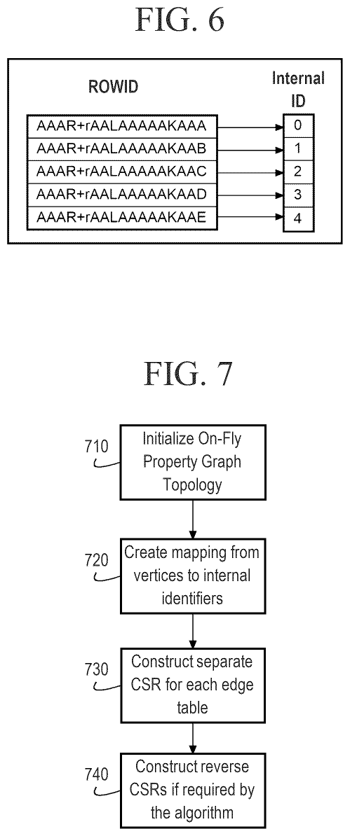

FIG. 6 illustrates mapping between ROWIDs and internal vertex identifiers in accordance with an embodiment. When fetching the results, the runtime maps ROWIDs to dense identifiers. Those dense identifiers are numbers starting in range [0, table_size-1]. ROWIDs are stored in a segmented array, and a separate hash-table is added in order to create a mapping between them and internal identifiers. This segmented array also serves as the reverse mapping between internal identifiers and ROWIDs. As the runtime scans each vertex table in its entirety, the runtime also loads all the vertex properties here. This optimization eliminates the need to load vertex properties in IMGA and combines multiple scans over vertex tables into a single scan.

### On-the-Fly Graph CSR

FIG. 7 is a flowchart illustrating on-the-fly graph index construction in accordance with an embodiment. The runtime initializes the on-the-fly property graph topology object (block 710). The on-the-fly property graph topology object is described in further detail below. The runtime then creates a mapping from each vertex to an internal identifier (block 720). The runtime iterates over vertex tables and for each of them, applies the procedure that was described above for creating on-the-fly identifiers. In order to construct CSRs, the runtime must scan the edge table, but also must know which primary key corresponds to which ROWID in both source and destination vertex tables. In an embodiment, the runtime performs the following query with two joins to construct a single CSR:
SELECT Source.rowid, Destination.rowid, [Edge.properties . . . ]
FROM Source
JOIN Edge ON Source.PK=Edge.FK src
JOIN Destination ON Edge.FK_dst=Destination.PK
ORDER BY Source.rowid
   Similar to the previous step, the runtime uses this step to load properties, thereby relieving the IMGA of extra work. The runtime then scans the table in increasing order with respect to the source ROWIDs. While fetching the results, the runtime populates the destination array sequentially and adds an entry to the source array each time it finds a new offset.

The runtime constructs reverse CSRs if required by the algorithm (block 740). Instead of the new table scan (which would be expensive, as tables are stored on the disk), the runtime uses the previously constructed forward CSR. The construction follows the procedure described above.

### On-the-Fly Graph Topology

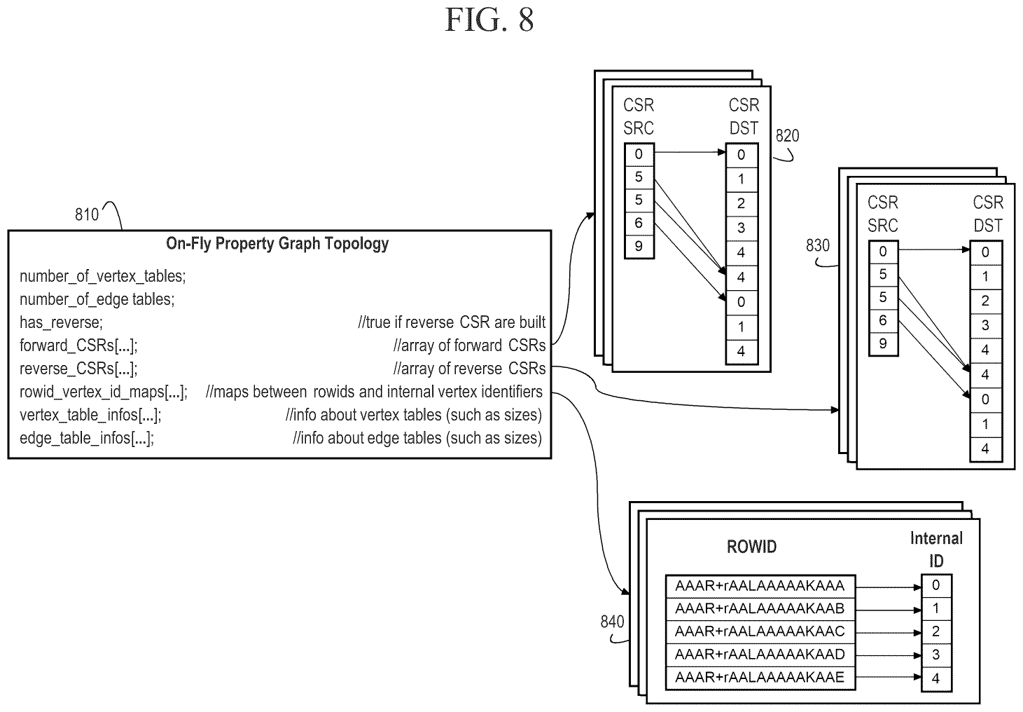

In the first step after the user calls for an execution of the graph algorithm, an on-the-fly graph topology object is created. This object is gradually filled with information about the graph topology during the subsequent steps. FIG. 8 illustrates an on-the-fly property graph topology structure in accordance with an embodiment. The on-the-fly property graph topology object 810 contains metadata information about the graph, i.e., the number of its vertex and edge tables, the size of each of them, whether the reverse CSR is required, etc. This structure contains pointers to CSRs (both forward 820 and reverse 830, if constructed), as well as to the hash map 840 where mappings between ROWIDs and internal identifiers are stored.

Integration with Index-Based Graph Algorithm Engine

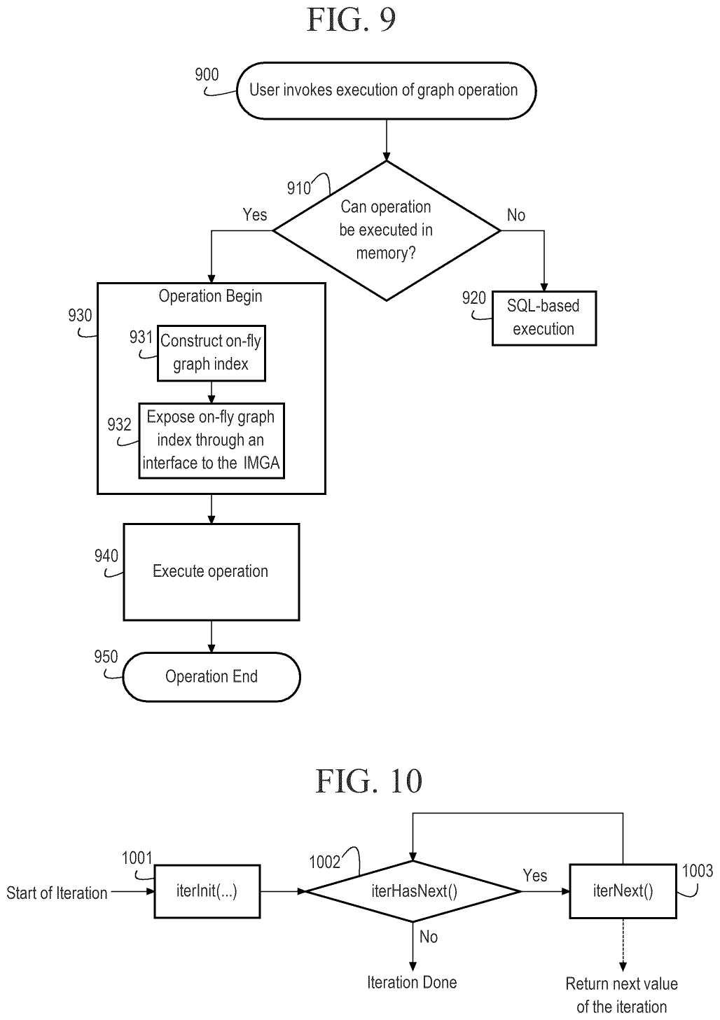

FIG. 9 illustrates graph operation execution integrated with an index-based graph algorithm engine in accordance with an embodiment. When the user starts execution of an algorithm (block 900), the first step is to check if the algorithm can be executed in-memory (block 910). If the algorithm cannot be executed in memory (block 910):No), then SQL-based execution is performed (block 920).

If the algorithm can be executed in memory (block 910:Yes), then in-memory execution begins (block 930). This execution is divided into three phases. First, a preparatory phase begins for the execution of the algorithm. During this phase, an on-the-fly graph index is constructed (block 931) and exposed through an interface to the IMGA (block 932).

Next, the runtime performs operation execution (block 940). This is the main phase, during which the algorithm execution interacts with IMGA, which in turn interacts with the on-the-fly graph index. The interaction between the IMGA and on-the-fly graph index is described in more detail below. Notice that during the operation execution (e.g., Bellman-Ford algorithm), properties are to be loaded; however, this step is performed during the vertex mappings for vertex properties and during the CSR construction for edge properties.

Finally, operation ends (block 950). This is the final cleanup phase of the execution. The on-the-fly topology is dropped during this phase.

### Input Elements Parsing

Input elements are specified by the user. In some embodiments, this can be done by defining a function that returns JSON. An example of such specification of the starting vertex in the Bellman-Ford algorithm is as follows:

```
CREATE OR REPLACE FUNCTION START_VERTEX
  RETURN JSON
IS
  vid JSON;
BEGIN
  EXECUTE IMMEDIATE
    ‘SELECT vid’ ||
    ‘ FROM GRAPH_TABLE(ldbc_graph’ ||
    ‘ MATCH (v IS Person)’ ||
    ‘ WHERE v.id = 933’ ||
    ‘ COLUMNS (VERTEX_ID(v) AS vid))’
  INTO vid;
  RETURN vid;
END;
/
```

At the start of the algorithm execution, these elements must be mapped to internal identifiers. For each element specified by the user, a query is made that fetches the row corresponding to that element. The algorithm execution then takes the ROWID of such a row and maps the element to the internal identifier using the ROWID vertex id map from the On-the-fly Property Graph Topology structure.

### Index Navigation

During the execution of the algorithm, the index is queried for the information regarding the vertices and edges. Various types of iterations are supported, including the following:
Iteration over all or a range of vertices
Iteration over all or a range of (edge, neighbor) pairs
Iteration over all or a range of outgoing (edge, neighbor) pairs for the corresponding vertex
Iteration over all or a range of incoming (edge, neighbor) pairs for the corresponding vertex
   Edges in particular correspond to indices in the CSR destination array, while neighbors correspond to the values in the destination array. The index of an edge is used only for fetching the value of the input property of that edge or storing the value of the output property. All iterators are supported in two types: sequential and parallel. Whether parallel iterators are used is decided by the algorithm itself.

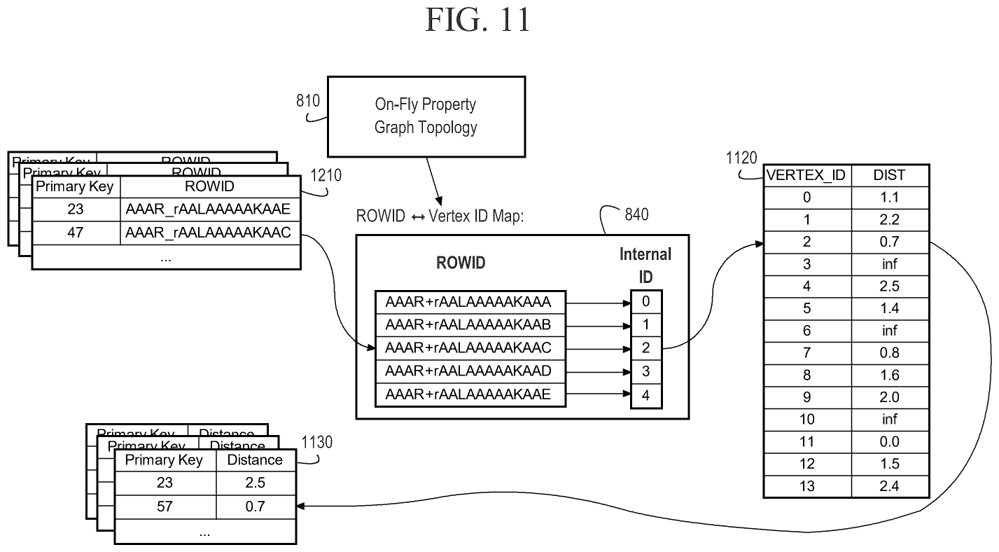

FIG. 10 illustrates the iteration pipeline with the interface exposed by the on-the-fly graph index to the In-Memory Graph Algorithm Runtime in accordance with an embodiment. The runtime initializes the iterator with arguments that specify the type of the iterator, range (if applicable), vertex (if applicable) (block 1001). The runtime checks if the iterator has a next value (block 1002). If this function returns false (block 1002:No), the iteration is completed. Otherwise, the runtime has more elements to iterate over. The runtime fetches the next value of the iterator (block 1003). This function both returns the value and moves the iterator for one position. Operation then returns to block 1002.

Alongside these, the on-the-fly graph index also provides to the IMGA a functionality of initializing parallel iterators. This initialization expects as input the number of iterators that parallel iterator is composed of. It then splits the iteration range in the corresponding number of ranges of equal size and initializes one sequential iterator per range.

### Property Materialization

FIG. 11 illustrates the process of property materialization in accordance with an embodiment. FIG. 11 refers to previous figures and tables (e.g., FIGS. 3 and 6 and Table 1). The graph algorithm returns output properties stored in a segmented array 1120 ordered with respect to the internal vertex identifier. In order to materialize all the vertex output properties, the process scans all the vertex tables of the graph. For each vertex table, the process fetches the ROWID (as shown in the vertex tables 1210 in the upper left corner) and uses the ROWID vertex id map 840 from the On-the-fly Property Graph Topology structure 810 to map this ROWID to the corresponding internal vertex identifier. This identifier is then used as the index in the segmented array of the output properties, which is provided by the algorithm. The corresponding value is fetched and stored in output table 1130.

### DBMS Overview

A database management system (DBMS) manages a database. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, a branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .java file) and the compiled version of the class (i.e. .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data type and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

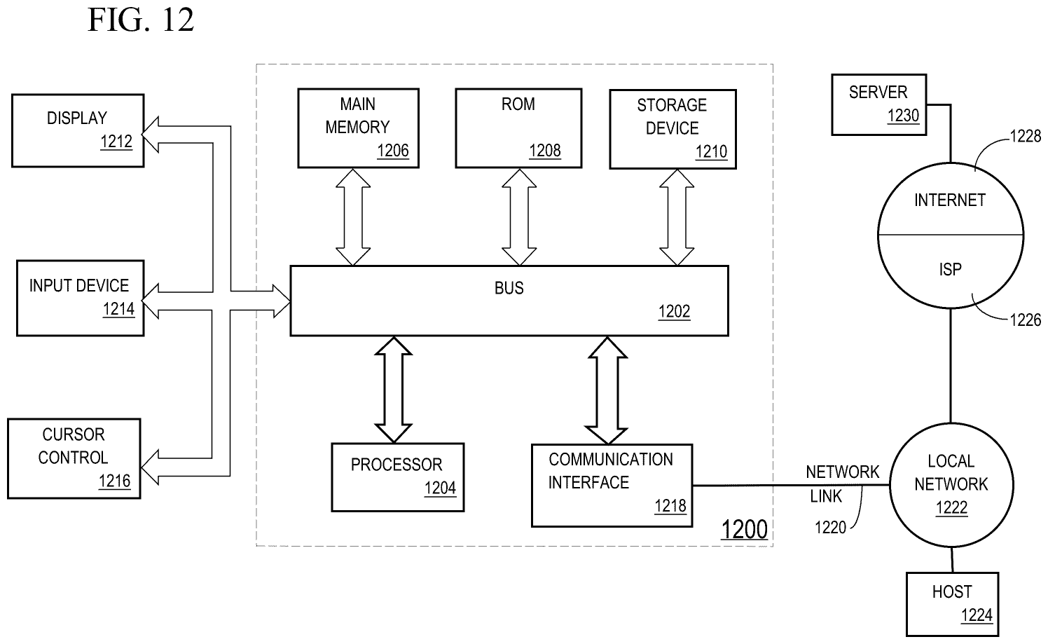

For example, FIG. 12 is a block diagram that illustrates a computer system 1200 upon which aspects of the illustrative embodiments may be implemented. Computer system 1200 includes a bus 1202 or other communication mechanism for communicating information, and a hardware processor 1204 coupled with bus 1202 for processing information. Hardware processor 1204 may be, for example, a general-purpose microprocessor.

Computer system 1200 also includes a main memory 1206, such as a random-access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk, optical disk, or solid-state drive is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1210. Volatile media includes dynamic memory, such as main memory 1206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world-wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

### Software Overview

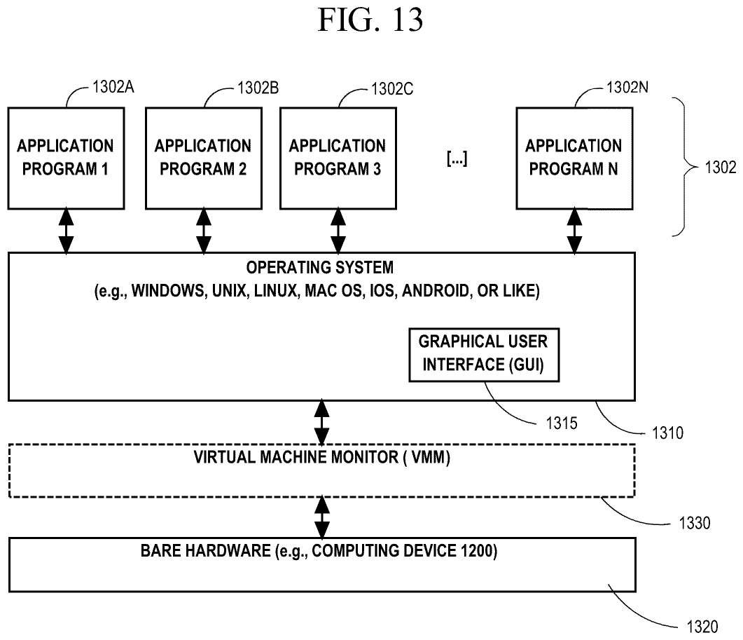

FIG. 13 is a block diagram of a basic software system 1300 that may be employed for controlling the operation of computer system 1200 upon which aspects of the illustrative embodiments may be implemented. Software system 1300 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1300 is provided for directing the operation of computer system 1200. Software system 1300, which may be stored in system memory (RAM) 1206 and on fixed storage (e.g., hard disk or flash memory) 1210, includes a kernel or operating system (OS) 1310.

The OS 1310 manages low-level aspects of computer operation, including managing execution of processes, memory allocation, file input and output (I/O), and device I/O. One or more application programs, represented as 1302A, 1302B, 1302C . . . 1302N, may be “loaded” (e.g., transferred from fixed storage 1210 into memory 1206) for execution by the system 1300. The applications or other software intended for use on computer system 1200 may also be stored as a set of downloadable computer-executable instructions, for example, for downloading and installation from an Internet location (e.g., a Web server, an app store, or other online service).

Software system 1300 includes a graphical user interface (GUI) 1315, for receiving user commands and data in a graphical (e.g., “point-and-click” or “touch gesture”) fashion. These inputs, in turn, may be acted upon by system 1300 in accordance with instructions from operating system 1310 and/or application(s) 1302. The GUI 1315 also serves to display the results of operation from the OS 1310 and application(s) 1302, whereupon the user may supply additional inputs or terminate the session (e.g., log off).

OS 1310 can execute directly on the bare hardware 1320 (e.g., processor(s) 1204) of computer system 1200. Alternatively, a hypervisor or virtual machine monitor (VMM) 1330 may be interposed between the bare hardware 1320 and the OS 1310. In this configuration, VMM 1330 acts as a software “cushion” or virtualization layer between the OS 1310 and the bare hardware 1320 of the computer system 1200.

VMM 1330 instantiates and runs one or more virtual machine instances (“guest machines”). Each guest machine comprises a “guest” operating system, such as OS 1310, and one or more applications, such as application(s) 1302, designed to execute on the guest operating system. The VMM 1330 presents the guest operating systems with a virtual operating platform and manages the execution of the guest operating systems.

In some instances, the VMM 1330 may allow a guest operating system to run as if it is running on the bare hardware 1320 of computer system 1200 directly. In these instances, the same version of the guest operating system configured to execute on the bare hardware 1320 directly may also execute on VMM 1330 without modification or reconfiguration. In other words, VMM 1330 may provide full hardware and CPU virtualization to a guest operating system in some instances.

In other instances, a guest operating system may be specially designed or configured to execute on VMM 1330 for efficiency. In these instances, the guest operating system is “aware” that it executes on a virtual machine monitor. In other words, VMM 1330 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
in response to a user invoking a graph operation on a graph in an in-memory graph algorithm (IMGA) runtime in a relational database management system (RDBMS), generating a set of one or more graph indexes in memory, wherein:
the graph is represented in the RDBMS as one or more vertex tables and one or more edge tables, and
generating the set of one or more graph indexes comprises:
generating a mapping of each database table vertex identifier in the one or more vertex tables to a corresponding internal identifier; and
for each edge table of the one or more edge tables, generating a graph index data structure representing edges of the edge table, wherein the graph index data structure represents each edge in the edge table as a source internal identifier and a destination internal identifier; and
executing the graph operation in the IMGA runtime using the set of one or more graph indexes,
wherein the method is performed by one or more computing devices.

2. The method of claim 1, wherein generating the set of one or more graph indexes further comprises:
initializing a property graph topology data structure containing metadata about the graph;
adding a pointer to the mapping to the property graph topology data structure; and
adding a pointer to the graph index data structure to the property graph topology data structure.

3. The method of claim 2, wherein the metadata about the graph comprises at least one of:
a number of vertex tables,
a number of edge tables,
information about the one or more vertex tables, or
information about the one or more edge tables.

4. The method of claim 2, wherein:
the metadata about the graph comprises an indication that one or more reverse graph index data structures are to be used for the graph operation, and
generating the set of one or more graph indexes further comprises, for each edge table of the one or more edge tables, generating a reverse graph index data structure representing edges of the edge table and adding a pointer to the reverse graph index data structure to the property graph topology data structure, wherein the reverse graph index data structure represents each edge in the edge table as a destination internal identifier and a source internal identifier.

5. The method of claim 1, wherein the database table vertex identifier comprises a row identifier or a primary key of a corresponding vertex table.

6. The method of claim 1, wherein the graph index data structure is a compressed sparse row (CSR) data structure.

7. The method of claim 1, wherein:
the graph operation generates an intermediate result comprising one or more output properties ordered with respect to internal identifier, and
executing the graph operation comprising fetching a database table vertex identifier for each internal identifier in the intermediate result.

8. The method of claim 1, wherein invocation of the graph operation specifies an input vertex identifier, the method further comprising generating a vertex identifier object based on the input vertex identifier.

9. The method of claim 8, wherein the vertex identifier object includes:
a graph owner,
a graph name,
an element table, and
a key value.

10. The method of claim 1, further comprising:
in response to completion of execution of the graph operation, removing the set of one or more graph indexes from memory.

11. One or more non-transitory computer-readable media storing instructions which, when executed by one or more processors, cause:
in response to a user invoking a graph operation on a graph in an in-memory graph algorithm (IMGA) runtime in a relational database management system (RDBMS), generating a set of one or more graph indexes in memory, wherein:
the graph is represented in the RDBMS as one or more vertex tables and one or more edge tables, and
generating the set of one or more graph indexes comprises:
generating a mapping of each database table vertex identifier in the one or more vertex tables to a corresponding internal identifier; and
for each edge table of the one or more edge tables, generating a graph index data structure representing edges of the edge table, wherein the graph index data structure represents each edge in the edge table as a source internal identifier and a destination internal identifier; and
executing the graph operation in the IMGA runtime using the set of one or more graph indexes.

12. The one or more non-transitory computer-readable media of claim 11, wherein generating the set of one or more graph indexes further comprises:
initializing a property graph topology data structure containing metadata about the graph;
adding a pointer to the mapping to the property graph topology data structure; and
adding a pointer to the graph index data structure to the property graph topology data structure.

13. The one or more non-transitory computer-readable media of claim 12, wherein the metadata about the graph comprises at least one of:
a number of vertex tables,
a number of edge tables,
information about the one or more vertex tables, or
information about the one or more edge tables.

14. The one or more non-transitory computer-readable media of claim 12, wherein:
the metadata about the graph comprises an indication that one or more reverse graph index data structures are to be used for the graph operation, and
generating the set of one or more graph indexes further comprises, for each edge table of the one or more edge tables, generating a reverse graph index data structure representing edges of the edge table and adding a pointer to the reverse graph index data structure to the property graph topology data structure, wherein the reverse graph index data structure represents each edge in the edge table as a destination internal identifier and a source internal identifier.

15. The one or more non-transitory computer-readable media of claim 11, wherein the database table vertex identifier comprises a row identifier or a primary key of a corresponding vertex table.

16. The one or more non-transitory computer-readable media of claim 11, wherein the graph index data structure is a compressed sparse row (CSR) data structure.

17. The one or more non-transitory computer-readable media of claim 11, wherein:
the graph operation generates an intermediate result comprising one or more output properties ordered with respect to internal identifier, and
executing the graph operation comprising fetching a database table vertex identifier for each internal identifier in the intermediate result.

18. The one or more non-transitory computer-readable media of claim 11, wherein invocation of the graph operation specifies an input vertex identifier, wherein the instructions further cause generating a vertex identifier object based on the input vertex identifier.

19. The one or more non-transitory computer-readable media of claim 18, wherein the vertex identifier object includes:
a graph owner,
a graph name,
an element table, and
a key value.

20. The one or more non-transitory computer-readable media of claim 11, wherein the instructions, when executed by the one or more processors, further cause:
in response to completion of execution of the graph operation, removing the set of one or more graph indexes from memory.
